(19) United States
(12) Patent Application Publication
(10) Pub. No.: US 2003/0131172 A1
(43) Pub. Date: Jul. 10, 2003

(54) Method for switching a control source of a computer display automatically and a main board using the method

(76) Inventor: Johnson Lin, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/040,403

(22) Filed: Jan. 9, 2002

(51) Int. Cl. G06F 13/36

(52) U.S. Cl. 710/306

(57) ABSTRACT

The present invention relates to a method for switching a control source of a computer display automatically, including (a) detecting if an AGP card is inserted into an AGP slot; (b) if the AGP card is inserted into the AGP slot, disabling an onboard VGA chip, and switching an AGP bus to the AGP slot; and (c) if the AGP card is detached from the AGP slot, enabling the VGA chip, and switching the AGP bus to the VGA chip. The present invention also relates to a main board including a detection circuit, and a switching circuit. The switching circuit is controlled by the detection circuit to determine if the north bridge chip is connected to the AGP slot or to the VGA chip.

### BACKGROUND OF THE INVENTION

1. Field of the Invention

The present invention relates to a method for switching a control source of a computer display automatically and a main board using the method.

2. Description of the Related Art

FIG. 3 shows a partial circuit block view of a conventional computer main board in accordance with the prior art, wherein the conventional computer main board has an onboard VGA chip. The computer main board may integrate the function of a display card to the VGA chip 60 on the computer main board. The VGA chip 60 usually uses a display chip having a lower price, such as ATI, RAGE 128, SIS305, SIS315 or the like, thereby reducing the cost. The computer main board may be provided with an AGP slot 70 for insertion of an AGP card, and a setter 80 for providing a switching function, so as to strengthen the image indication function.

The setter 80 may set the VGA chip 60 to an enabling status or a disabling status by using a jumper. When the VGA chip 60 is set at the enabling status, the image data from the north bridge chip 90 may be sent into the VGA chip 60 through an AGP bus, may then be processed by the VGA chip 60, and may then output to the computer display. When the VGA chip 60 is set at the disabling status, the image data from the north bridge chip 90 may be sent into the AGP slot 70 through the AGP bus, may then be processed by an AGP card inserted in the AGP slot 70, and may then output to the computer display.

When the AGP card is inserted in the AGP slot 70, the AGP card may be used as the control source of the computer display after the VGA chip 60 is set at the disabling status. When the VGA chip 60 is used as the control source of the computer display, the VGA chip 60 has to be set at the enabling status, and the AGP card has to be removed from the AGP slot 70.

Thus, the computer main board may satisfy the mounting requirement of a lower price computer, and may use an AGP slot 70 for insertion of an AGP card, so as to enhance the indication capacity and quality of the computer display.

However, the conventional computer main board having an onboard VGA chip has the following disadvantages.

When the user wishes to change the control source of the computer display, he has to use the setter to set the VGA chip 60 to an enabling status or a disabling status by using a jumper with aid of a technical book, and then insert the AGP card into the AGP slot 70 or remove the AGP card from the AGP slot 70, thereby causing inconvenience to the user or easily producing an error.

In addition, the north bridge chip 90 is connected to the VGA chip 60 through the AGP bus, and is connected to the AGP slot 70 through a branch of the AGP bus. Thus, when the VGA chip 60 is set at the disabling status, and the AGP card inserted in the AGP slot 70 is used, the signal quality of the image data sent from the north bridge chip 90 into the AGP slot 70 through the AGP bus will be easily affected by the branch “A” (which is connected to the VGA chip 60) of the AGP bus. On the other hand, when the VGA chip 60 is set at the enabling status, and the AGP card is removed from the AGP slot 70, the signal quality of the image data sent from the north bridge chip 90 into the VGA chip 60 through the AGP bus will be easily affected by the branches “B1” and “B2” (which are connected to the AGP slot 70) of the AGP bus. Thus, when north bridge chip 90 is transferring the image data, the signal quality of the image data is easily affected by the branches “A”, “B1” and “B2” of the AGP bus, so that the system is unstable.

### SUMMARY OF THE INVENTION

The present invention has arisen to mitigate and/or obviate the disadvantage of the conventional the conventional computer main board having an onboard VGA chip.

The primary objective of the present invention is to provide a method for switching a control source of a computer display automatically and a main board using the method, wherein the user only needs to decide if he wants to use the AGP card having a better performance, and the main board may automatically determine if the image data sent from the north bridge chip is processed and output by the VGA chip or by the AGP card, so that the user needs not to adjust the jumper, thereby facilitating the user operating the computer display, and thereby preventing from incurring errors.

Another objective of the present invention is to provide a method for switching a control source of a computer display automatically and a main board using the method, wherein the image data sent from the north bridge chip may be transferred by two independent paths without interference and interruption being produced therebetween, so that when the image data is transferred by one of the two independent paths, existence of the other path will not affect or interfere with the signal quality during the transferring process, so that the computer may be operated stably.

In accordance with one aspect of the present invention, there is provided a method for switching a control source of a computer display automatically, comprising the steps of:

(a) detecting if an AGP card is inserted into an AGP slot;

(b) if the AGP card is inserted into the AGP slot, disabling an onboard VGA chip in a computer main board, and then switching an AGP bus to the AGP slot; and

(c) if the AGP card is detached from the AGP slot, enabling the VGA chip, and then switching the AGP bus to the VGA chip.

In accordance with another aspect of the present invention, there is provided a device for switching the controlling source of a computer system, the computer system comprising a VGA chip, an AGP slot, and a north bridge chip, the switching device comprising:

a detection circuit, having an input side connected to the AGP slot, so as to detect if the AGP slot is disposed at an idling state, and an output side connected to the VGA chip, to enable or disable the VGA chip; and

a switching circuit, having a first input side connected to the output side of the detection circuit, and a second input side connected to the north bridge chip, the switching circuit having a first output side connected to the AGP slot, and a second output side connected to the VGA chip, the switching circuit being controlled by the detection circuit to control the north bridge chip to be connected to the AGP slot or to the VGA chip.

Preferably, the north bridge chip is connected to the AGP slot through the switching circuit by an AGP bus.

Preferably, the north bridge chip is connected to the VGA chip through the switching circuit by an AGP bus.

Further benefits and advantages of the present invention will become apparent after a careful reading of the detailed description with appropriate reference to the accompanying drawings.

### BRIEF DESCRIPTION OF THE DRAWINGS

FIG. 1 is a flow chart of a method for switching a control source of a computer display automatically in accordance with a preferred embodiment of the present invention;

FIG. 2 is a block view of a part of the circuit of a computer main board using the method in accordance with a preferred embodiment of the present invention; and

FIG. 3 is a block view of a part of the circuit of a conventional computer main board in accordance with the prior art.

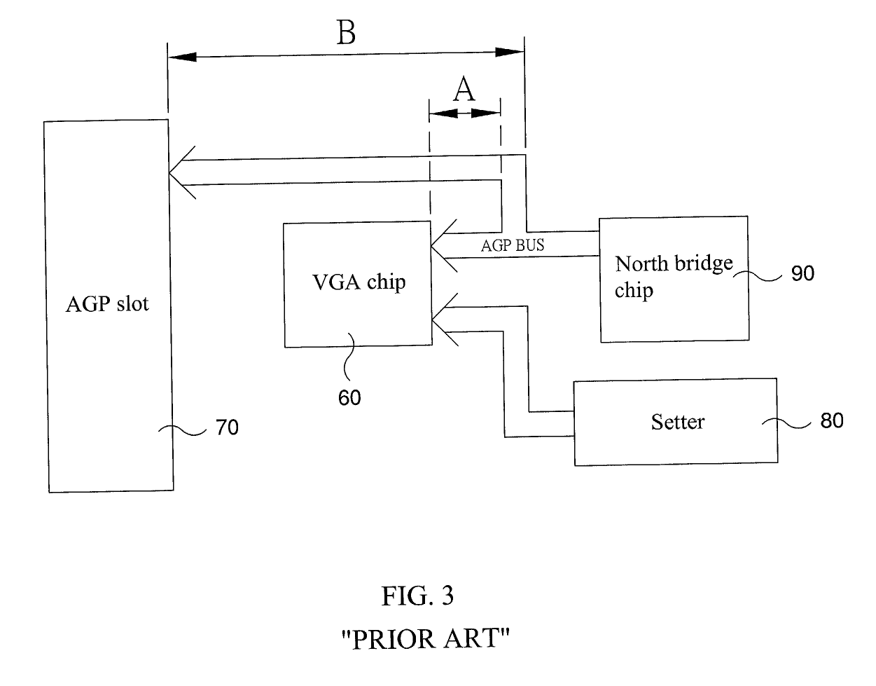

### DETAILED DESCRIPTION OF THE INVENTION

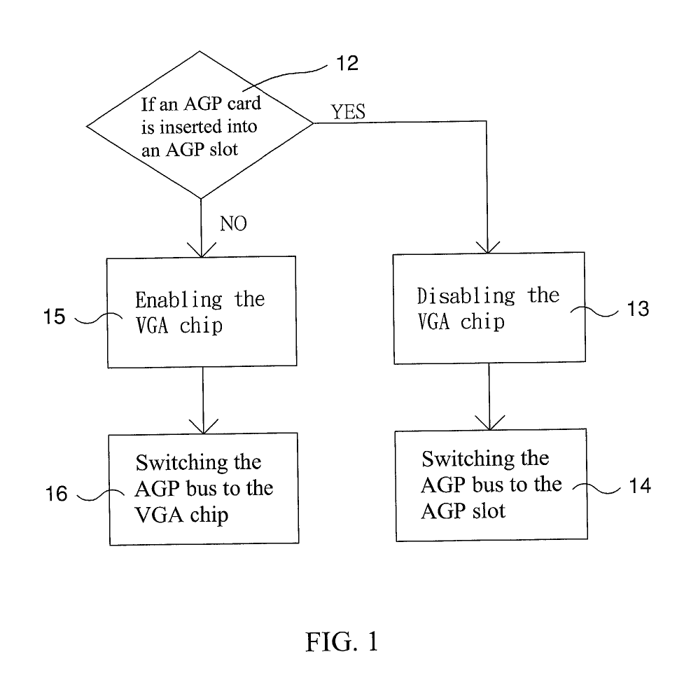

Referring to the drawings and initially to FIG. 1, a method for switching a control source of a computer display automatically in accordance with a preferred embodiment of the present invention comprises the following steps:

(a) detecting if an AGP card is inserted into an AGP slot (block 12);

(b) if the AGP card is inserted into the AGP slot, disabling a VGA chip (block 13), and then switching an AGP bus to the AGP slot (block 14); and

(c) if the AGP card is detached from the AGP slot, enabling the VGA chip (block 15), and then switching the AGP bus to the VGA chip (block 16).

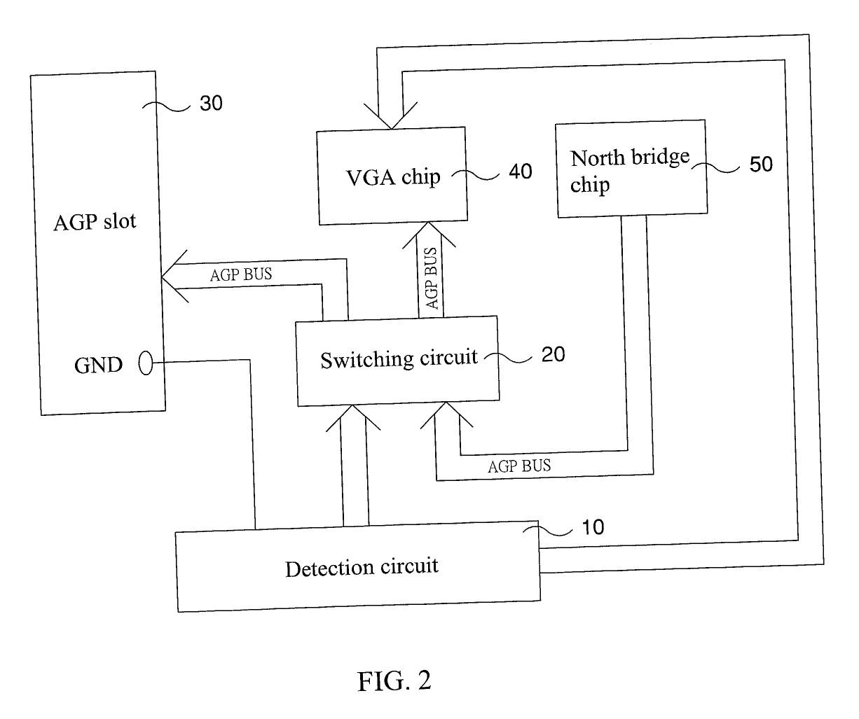

As shown in FIG. 1 with reference to FIG. 2, when the user chooses to use the AGP card, and inserts the AGP card into the AGP slot 30, connection between the VGA chip 40 and the north bridge chip 50 on the main board is interrupted instantly by using the above-mentioned method, and the AGP card is connected with the north bridge chip 50 simultaneously, so that the AGP card may be used to control operation of the computer display.

If the user only needs the VGA chip 40 on the main board to control operation of the computer display, the AGP slot 30 may be disposed at an idling state (e.g., the AGP card is not inserted into the AGP slot 30 or the AGP card is removed from the AGP slot 30), whereby connection between the AGP slot 30 and the north bridge chip 50 on the main board is interrupted instantly by using the above-mentioned method, and the VGA chip 40 is connected with the north bridge chip 50 simultaneously, so that the VGA chip 40 may be used to control operation of the computer display.

Referring to FIG. 2, a part of the circuit block view of a computer main board using the above-mentioned method in accordance with a preferred embodiment of the present invention is shown. The computer main board may automatically switch the control source of the computer display to the onboard VGA chip of the computer main board or to the AGP card that is inserted into the AGP slot.

The computer main board is provided with a detection circuit 10, and a switching circuit 20. The detection circuit 10 is connected to an AGP slot 30, so as to detect if the AGP slot 30 is disposed at an idling state. The detection circuit 10 is also connected to the switching circuit 20, to control operation of the switching circuit 20. The detection circuit 10 is further connected to a VGA chip 40, to enable or disable the VGA chip 40.

The switching circuit 20 may connect a north bridge chip 50 with the AGP slot 30 by the AGP bus, and may connect the north bridge chip 50 with the VGA chip 40 by the AGP bus. In the preferred embodiment of the present invention, the detection circuit 10 may be a control circuit controlled by transistors, and the switching circuit 20 may be a quick switch.

By the above-mentioned circuit structure, the detection circuit 10 may be used to detect if the AGP card is inserted into the AGP slot 30. If the AGP card is not inserted into the AGP slot 30 or the AGP card is removed from the AGP slot 30, the detection circuit 10 may enable the VGA chip 40, and may drive the switching circuit 20 to connect the north bridge chip 50 with the VGA chip 40 by the AGP bus, so that the image data sent from the north bridge chip 50 may be processed by the VGA chip 40 and the related circuit, and may then be output to the computer display.

If the AGP card is inserted into the AGP slot 30, the detection circuit 10 may disable the VGA chip 40, and may drive the switching circuit 20 to connect the north bridge chip 50 with the AGP slot 30 by the AGP bus, so that the image data sent from the north bridge chip 50 may be processed by the AGP card in the AGP slot 30, and may then be output to the computer display.

Thus, the user only needs to decide if he wants to use the AGP card having a better performance, and the main board may automatically determine if the image data sent from the north bridge chip 50 is processed and output by the VGA chip 40 or by the AGP card, so that the user needs not to adjust the jumper, thereby facilitating the user operating the computer display, and thereby preventing from incurring errors.

In addition, when the AGP card is operated, the VGA chip 40 is disabled by the detection circuit 10, and the image data is sent from the north bridge chip 50 through the switching circuit 20 and the AGP card into the computer display. On the other hand, when the AGP card is not inserted into the AGP slot 30 or the AGP card is removed from the AGP slot 30, the VGA chip 40 is enabled by the detection circuit 10, and the image data is sent from the north bridge chip 50 through the switching circuit 20 and the VGA chip 40 into the computer display. Thus, for the north bridge chip 50, the image data may be transferred by two independent paths without interference and interruption being produced therebetween, so that when the image data is transferred by one of the two independent paths, existence of the other path will not affect or interfere with the signal quality during the transferring process, so that the computer may be operated stably.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A method for switching a control source of a computer display automatically, comprising the steps of:
(a) detecting if an AGP card is inserted into an AGP slot;
(b) if the AGP card is inserted into the AGP slot, disabling an onboard VGA chip in a computer main board, and then switching an AGP bus to the AGP slot; and
(c) if the AGP card is detached from the AGP slot, enabling the VGA chip, and then switching the AGP bus to the VGA chip.

2. A device for switching the controlling source of a computer system, the computer system comprising a VGA chip, an AGP slot, and a north bridge chip, the switching device comprising:
a detection circuit, having an input side connected to the AGP slot, so as to detect if the AGP slot is disposed at an idling state, and an output side connected to the VGA chip, to enable or disable the VGA chip; and
a switching circuit, having a first input side connected to the output side of the detection circuit, and a second input side connected to the north bridge chip, the switching circuit having a first output side connected to the AGP slot, and a second output side connected to the VGA chip, the switching circuit being controlled by the detection circuit to control the north bridge chip to be connected to the AGP slot or to the VGA chip.

3. The switching device in accordance with claim 2, wherein the north bridge chip is connected to the AGP slot through the switching circuit by an AGP bus.

4. The switching device in accordance with claim 2, wherein the north bridge chip is connected to the VGA chip through the switching circuit by an AGP bus.

5. The switching device in accordance with claim 2, wherein the detection circuit is a control circuit controlled by transistors.

6. The main board in accordance with claim 2, wherein the switching circuit is a quick switch.
